(19) United States
(12) Patent Application Publication
(10) Pub. No.: US 2018/0314110 A1
(43) Pub. Date: Nov. 1, 2018

(54) BACKLIGHT MODULE AND SURFACE LIGHT SOURCE ASSEMBLY THEREOF

(71) Applicant: Young Lighting Technology Inc., Hsin-Chu (TW)

(72) Inventors: Hua Chen, Hsin-Chu (TW); Ching-Hung Chen, Hsin-Chu (TW); Chung-Hung Fang, Hsin-Chu (TW); Wei-Ching Wu, Hsin-Chu (TW)

(21) Appl. No.: 15/956,717

(22) Filed: Apr. 18, 2018

(30) Foreign Application Priority Data
Apr. 27, 2017 (CN) 201710288045.70

(51) Int. Cl. G02F 1/1335; F21V 8/00; G02B 6/24

(52) U.S. Cl. CPC G02F 1/133602; G02B 6/243; G02B 6/0016

(57) ABSTRACT

A surface light source assembly includes at least one light emitting element and a light guide plate. Each light emitting element has an annular light emitting side surface. The light guide plate has a bottom surface and a light emission surface opposite to each other. The bottom surface has at least one accommodation groove to accommodate the at least one light emitting element. The accommodation groove has a light incident surface. The light incident surface surrounds the annular light emitting side surface of the light emitting element located in the accommodation groove. The light emission surface of the light guide plate is a convex surface. A backlight module having a plurality of above light source assemblies is also provided. The surface light source assembly and the backlight module of the invention can enhance the luminance uniformity and suppress the light leakage at the edge of the light guide plate.

### CROSS-REFERENCE TO RELATED APPLICATION

THIS APPLICATION CLAIMS THE PRIORITY BENEFIT OF CHINA APPLICATION (CN201710288045.7 FILED ON Apr. 27 2017). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a light source module, and more particularly to a backlight module and its surface light source assembly.

### BACKGROUND OF THE INVENTION

The liquid crystal display panel of the liquid crystal display device does not emit light, so that the backlight module is required for providing the surface light source. The backlight module includes a direct-type backlight module and a side-type backlight module. In the current side-type backlight module, the light emitting diode light bar is disposed on the side of the light guide plate and the light guide plate is disposed with mesh spots. After entering the light guide plate, the light provided by the light emitting diode light bar exits from the light emission surface of the light guide plate via the mesh spots. However, since the light emitting diode bar is disposed on the side of the light guide plate, the problem of having uneven luminance may occur, which is not advantageous for local dimming.

In the current direct-type backlight module, a plurality of light emitting diodes arranged in a two-dimensional array is disposed below the diffusion plate. In order to reduce the number of light emitting diodes, a secondary lens is disposed corresponding to each of the light emitting diodes to increase the light emitting angle of the light emitting diode. Compared with the side-type backlight module, the direct-type backlight module has better luminance uniformity and is conducive to local dimming, but has a problem of having a greater thickness.

The known technology further develops a mix-type backlight module, which mainly uses a plurality of light guide plates to replace the secondary lens used in the direct-type backlight module to reduce the overall thickness of the mix-type backlight module. However, the corners of each light guide plate may have obvious dark areas and the edge of each light guide plate may have light leakage. Thus, the conventional mix-type backlight module has a problem of having uneven luminance.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a surface light source assembly that can be applied to a backlight module to improve the problem of having uneven luminance in the conventional mix-type backlight module.

The invention provides a backlight module to improve the problem of having uneven luminance in the conventional mix-type backlight module and the problem of light leakage at the edge of the light guide plate.

Other objectives and advantages of the invention will become apparent from the technical features disclosed in the invention.

In order to achieve one or some or all of the above objectives or other objectives, an embodiment of the invention provides a surface light source assembly, which includes at least one light emitting element and a light guide plate. Each light emitting element has an annular light emitting side surface. The light guide plate has a bottom surface and a light emission surface opposite to each other. The bottom surface has at least one accommodation groove to accommodate the at least one light emitting element. Each accommodation groove has a light incident surface. The light incident surface surrounds the annular light emitting side surface of the light emitting element located in the accommodation groove. The light emission surface of the light guide plate is a convex surface.

In order to achieve one or some or all of the above objectives or other objectives, an embodiment of the invention provides a backlight module including a plurality of above surface light source assemblies, wherein the light guide plates of the surface light source assemblies are spliced to each other.

In summary, since the light emitting element disposed in the accommodation groove of the light guide plate has the annular light emitting side surface which emits light to the corners of the light guide plate in addition emits light to the side surfaces of the light guide plate, the surface light source assembly of the embodiment of the invention can improve the problem of corner dark area of the light guide plate of the conventional mix-type backlight module. Further, the light emission surface of the light guide plate is designed as a convex surface which can change the incident angle of the light in the light guide plate on the light emission surface, the light originally to be reflected to the side surface of the light guide plate and leaked from the side surface will be reflected to the light guide plate and exit from the light emission surface, thus, the light leakage at the edge of the light guide plate of the conventional mix-type backlight module is improved. As a result, the surface light source assembly of the embodiment can enhance luminance uniformity and suppress edge light leakage. In addition, since the annular gap is disposed with the light absorbing layer, the surface light source assembly of the embodiment of the invention can improve the problem of bright pattern occurring on the light guide plate corresponding to the annular gap, thereby improving the uniformity of light emission. Since employing a plurality of the above surface light source assemblies, the backlight module of the embodiment of the invention can improve the problem of having uneven luminance in the conventional mix-type backlight module. In addition, since the light absorbing layer is disposed in the gap between any two adjacent light guide plates or openings are disposed in the reflective layer, the backlight module of the embodiment of the invention can improve the problem of having uneven light emission at the positions where the light guide plates are stitched, thereby improving the uniformity of light emission.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a surface light source assembly in accordance with an embodiment of the invention;

FIG. 2 is a schematic cross-sectional view of FIG. 1;

FIG. 3 is a schematic cross-sectional view of a surface light source assembly in accordance with another embodiment of the invention;

FIG. 4 is a schematic cross-sectional view of a surface light source assembly in accordance with another embodiment of the invention;

FIG. 5 is a schematic bottom view of a backlight module in accordance with an embodiment of the invention;

FIG. 6 is a schematic cross-sectional view of a backlight module in accordance with another embodiment of the invention;

FIG. 7 is a schematic cross-sectional view of a backlight module in accordance with another embodiment of the invention; and

FIG. 8 is a schematic bottom view of a backlight module in accordance with another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

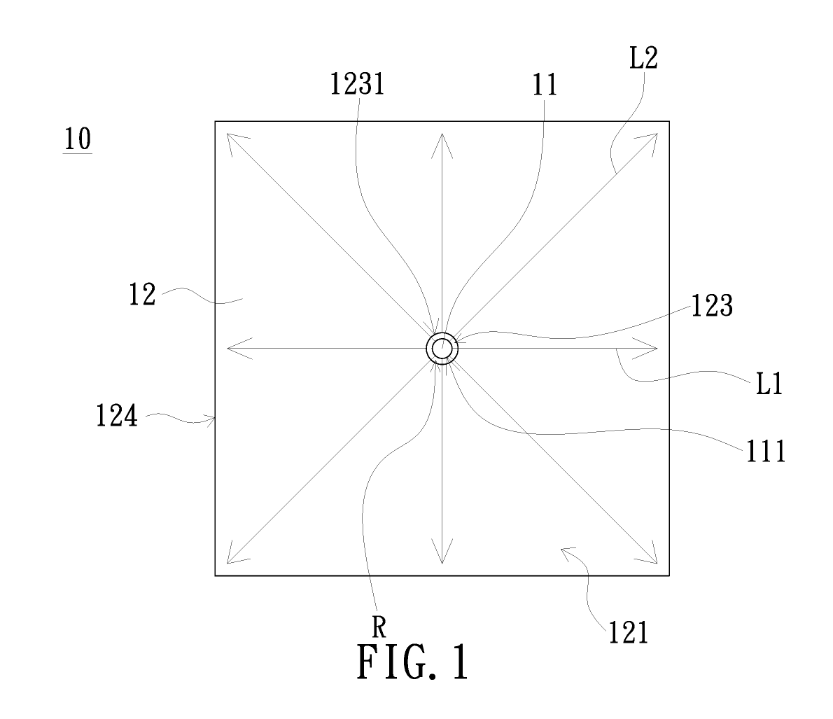

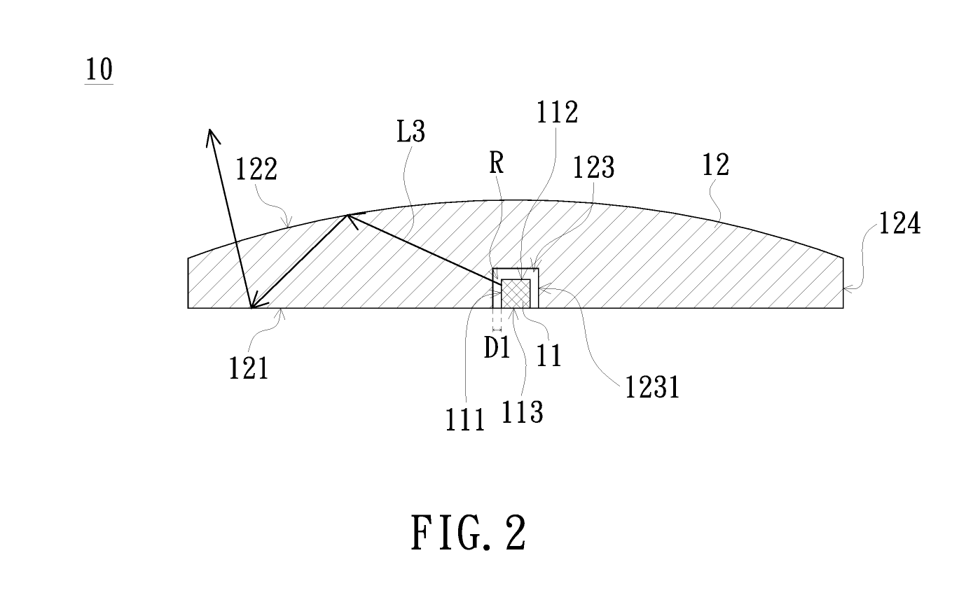

FIG. 1 is a schematic cross-sectional view of a surface light source assembly in accordance with an embodiment of the invention. FIG. 2 is a schematic cross-sectional view of FIG. 1. Please refer to FIGS. 1 and 2. The surface light source assembly 10 of the embodiment includes at least one light emitting element 11 and a light guide plate 12, and FIG. 1 is exemplified by including one light emitting element 11. Each of the light emitting elements 11 has an annular light emitting side surface 111. The light guide plate 12 has a bottom surface 121 and a light emission surface 122 opposite to each other. The bottom surface 121 has at least one accommodation groove 123 for accommodating at least one light emitting element 11. The number of the accommodation grooves 123 is, for example, corresponding to the number of the light emitting elements 11, and FIG. 1 is exemplified by that one accommodation groove 123 accommodates one light emitting element 11. Each of the accommodation grooves 123 has a light incident surface 1231. The light incident surface 1231 surrounds the annular light emitting side surface 111 of the light emitting element 11 located in the accommodation groove 123, wherein the light emission surface 122 of the light guide plate 12 is a convex surface. In one embodiment, there is an annular gap R between the light incident surface 1231 and the annular light emitting side surface 111 for example.

The light emitting element 11 further has, for example, a top surface 112 and a lower bottom surface 113 opposite to each other. The lower bottom surface 113 is adjacent to the bottom surface 121 of the light guide plate 12. The annular light emitting side surface 111 is connected between the top surface 112 and the lower bottom surface 113. The top surface 112 does not emit light. The light emitting element 11 is, for example, a light emitting diode. In addition, in one embodiment, the light emitting element having the annular light emitting side surface may be spliced by a plurality of side-emitting light emitting sources. Although the embodiment is exemplified by one light emitting element 11, the invention is not limited thereto. For example, the number of the light emitting elements 11 is plural, the number of the accommodation grooves 123 is also plural, and the light emitting elements 11 are disposed in the accommodation grooves 123 respectively. Each of the accommodation grooves 123 may be disposed with one or more light emitting elements 11.

The light guide plate 12 has, for example, four side surfaces 124, and the side surfaces 124 are connected between the bottom surface 121 and the light emission surface 122, but the invention does not limit the number of the side surfaces 124 of the light guide plate 12 and the specific shape of the light guide plate 12. For example, the light guide plate 12 of the embodiment is a square structure having four side surfaces 124, and the accommodation groove 123 is a cylindrical accommodation groove.

The light emission surface 122 is a convex surface and the height of the light emission surface 122 is gradually decreased from the center toward the side surface 124. The convex surface may be a curved surface or may include one or more slopes inclined from the center toward the side surface 124.

The accommodation groove 123 is, for example, disposed at the center of the bottom surface 121 of the light guide plate 12 so that the light emitting element 11 is located at the center of the bottom surface 121 of the light guide plate 12. In consideration of the assembly tolerances, the volume of the accommodation groove 123 of the light guide plate 12 is designed to be larger than the volume of the light emitting element 11, so that there is the annular gap R between the light emitting element 11 and the light guide plate 12. In one embodiment, the width D1 of the annular gap R is greater than 0 mm and less than or equal to 1 mm. In the embodiment, the annular gap R is exemplified by having a coincident width D1; however, in other embodiments, the width D1 of the annular gap R may not be coincident. In addition, the invention does not limit the position of the accommodation groove 123 to the bottom surface 121. The accommodation groove 123 can be disposed at other suitable positions of the bottom surface 121 of the light guide plate 12 in accordance with the design requirements, that is, the light emitting element 11 is not necessarily to be located at the center of the bottom surface 121 of the light guide plate 12.

In order to allow the light entering the light guide plate 12 to exit from the light emission surface 122, the light guide plate 12 may further include a plurality of dotted microstructures (not shown). The dotted microstructures may be disposed on the bottom surface 121 or the light emission surface 122 to break the total reflection of the light in the light guide plate 12, so that the light can exit from the light emission surface 122. The size and distribution density of the dotted microstructures may be adjusted in accordance with the design requirements, and the invention is not limited thereto.

In the surface light source assembly 10 of the embodiment, since the light emitting element 11 has the annular light emitting side surface 111 which emits light (e.g., light L2) to the corners of the light guide plate 12 in addition emits light (e.g., light L1) to the side surfaces 124 of the light guide plate 12, a significant corner dark area is avoided to be formed on the light guide plate 12. Further, based on that the light emission surface 122 of the light guide plate 12 is a convex surface which can change the incident angle of the light (e.g., light L3) in the light guide plate 12 on the light emission surface 122, the light L3 originally to be totally reflected to the side surface 124 of the light guide plate 12 and leaked from the side surface 124 in the case the light emission surface is a flat surface will be reflected to the bottom surface 121 of the light guide plate 12, reflected by the bottom surface and exit from the light emission surface 122, thereby improving the light leakage at the edge of the light guide plate. As a result, the surface light source assembly 10 of the embodiment can increase the uniformity of light emission.

The surface light source assembly 10 usually further includes a substrate (not shown) to carry the light emitting element 11. For example, the substrate may be a printed circuit board for carrying and electrically connecting the light emitting element 11, and the substrate is disposed on the bottom surface 121 of the light guide plate 12. Since the substrate covers the annular gap R, the portion of the light having a larger angle and emitted from the annular light emitting side surface 111 toward the bottom surface 121 is incident to the substrate, reflected by the substrate, and exits from the portion of the light emission surface 122 corresponding to the accommodation groove 123. As a result, a clear bright pattern is formed on the portion of the light emission surface 122 corresponding to the accommodation groove 123, which may result in uneven light emission.

Therefore, the portion of the light emission surface 122 of the embodiment corresponding to the accommodation groove 123 may be designed as a matte surface. Specifically, in one embodiment, the entire portion of the light emission surface 122 corresponding to the accommodation groove 123 may be designed as a matte surface to improve the problem of the bright pattern, but the invention is not limited thereto. In another embodiment, only the portion of the light emission surface 122 corresponding to the annular gap R may be designed as a matte surface.

In addition, the surface light source assembly 10 may further include a diffusion plate (not shown) or other optical films disposed above the light emission surface 122. In one embodiment, the diffusion plate or other optical films may be disposed only above the entire portion of the light emission surface 122 corresponding to the accommodation groove 123 or only above the portion of the light emission surface 122 corresponding to the annular gap R to increase the uniformity of light emission.

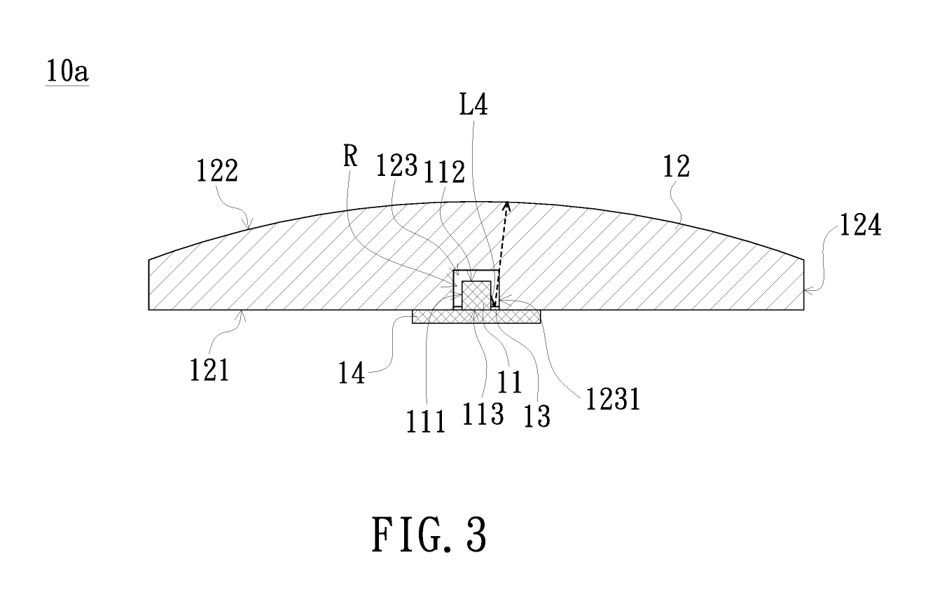

FIG. 3 is a schematic cross-sectional view of a surface light source assembly in accordance with another embodiment of the invention. Please refer to FIG. 3. The surface light source assembly 10a of the embodiment is similar to the surface light source assembly 10 of FIG. 2, and the main difference is that the surface light source assembly 10a of the embodiment further includes a light absorbing layer 13. Specifically, the light absorbing layer 13 of the embodiment is adjacent to the bottom surface 121 of the light guide plate 12 and is disposed corresponding to the annular gap R. The light absorbing layer 13 of the embodiment is, for example, disposed corresponding to the annular gap R as an annular light absorbing layer. However, in other embodiments, the light absorbing layer 13 in the annular gap R may be disposed to surround one side, two sides or more of the light emitting element 11 in accordance with the design requirements. Further, the surface light source assembly 10a of the embodiment further includes, for example, a substrate 14. The light emitting element 11 is disposed on the substrate 14 and accommodated in the accommodation groove 123, wherein the light absorbing layer 13 is disposed on the substrate 14. The light absorbing layer 13 is, for example, a paint material, a tape or a plating layer having a low reflectance (high light absorption), but the invention is not limited thereto. For example, the light absorbing layer 13 may be a black tape and attached to the substrate 14 corresponding to the annular gap R. In one embodiment, the substrate 14 is a printed circuit board for example, and the light absorbing layer 13 is a printed pattern layer of the substrate 14. That is, the light absorbing layer 13 can be printed when the substrate 14 is manufactured, so that the additional step of disposing the light absorbing layer 13 can be omitted.

By disposing the light absorbing layer 13 in the annular gap R, the portion of the light (e.g., light L4) having a larger light exit angle and emitted from the light emitting element 11 toward the bottom surface 121 can be absorbed, thereby improving the problem of bright pattern occurring on the portion of the light emission surface 122 of the light guide plate 12 corresponding to the annular gap R.

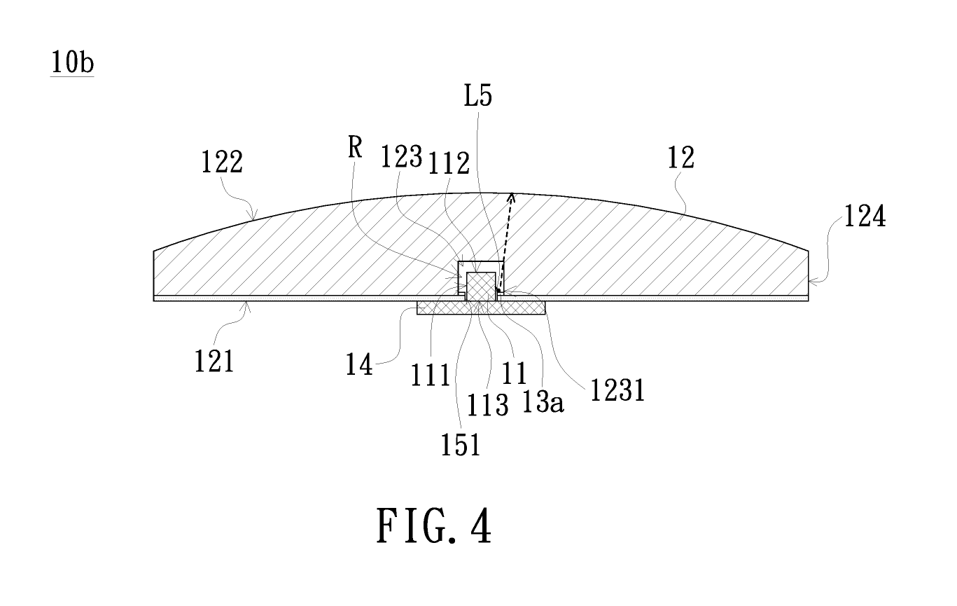

FIG. 4 is a schematic cross-sectional view of a surface light source assembly in accordance with another embodiment of the invention. Please refer to FIG. 4. The surface light source assembly 10b of the embodiment is similar to the above-described surface light source assembly 10a, and the main difference is that the surface light source assembly 10b further includes a reflective sheet 15. The reflective sheet 15 is disposed on the bottom surface 121 of the light guide plate 12 and located on the substrate 14. The reflective sheet 15 has at least one opening 151, and the light emitting element 11 is penetrately disposed in the opening 151. In addition, the light absorbing layer 13a of the embodiment is disposed on the reflective sheet 15. For example, the light absorbing layer 13a is, for example, a paint, a tape or a plating layer having a low reflectance (high light absorption), but the invention is not limited thereto. The light absorbing layer 13a is disposed on the reflective sheet 15 and corresponding to the annular gap R. The light absorbing layer 13a can absorb the portion of the light (e.g., light L5) having a larger light emission angle and emitted from the light emitting element 11 toward the bottom surface 121, thereby improving the problem of bright pattern occurring on the portion of the light emission surface 122 of the light guide plate 12 corresponding to the annular gap R.

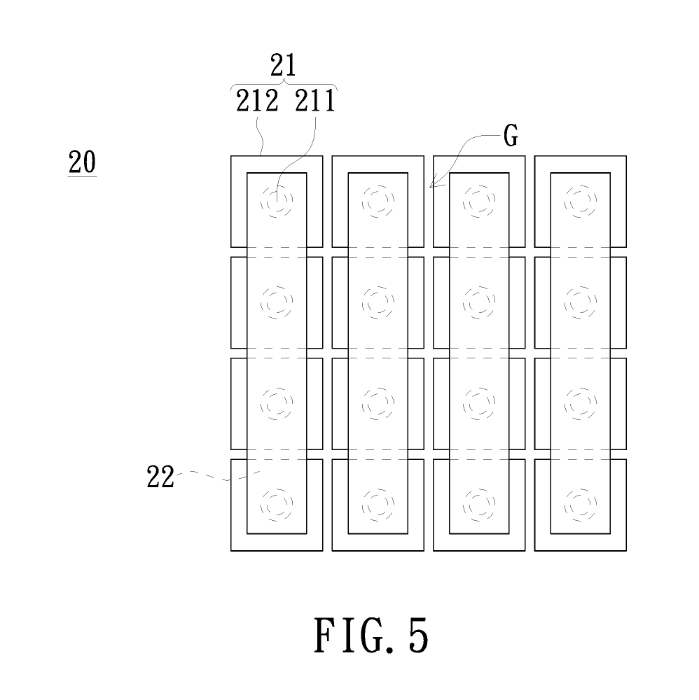

FIG. 5 is a schematic bottom view of a backlight module in accordance with an embodiment of the invention. Please refer to FIG. 5. The backlight module 20 of the embodiment includes a plurality of surface light source assemblies 21. Each of the surface light source assemblies 21 includes a light emitting element 211 and a light guide plate 212. The light guide plates 212 of the surface light source assemblies 21 are spliced into a large-sized light guide structure. The surface light source assembly 21 may be a surface light source assembly of any of the embodiments described above, such as the surface light source assembly 10, 10a or 10b. Since employing the surface light source assembly of any of the above embodiments, the backlight module 20a can provide a surface light source having better luminance uniformity. In addition, the plurality of surface light source assemblies 21 may share one substrate 22, and FIG. 5 is exemplified by that four light emitting elements 211 are carried by one substrate 22, but the invention is not limited thereto. For example, all of the light emitting elements 211 may be carried by a single substrate 22.

It is to be noted that when the light guide plates 212 are spliced, there is a gap G between any two adjacent light guide plates 212 in consideration of the shrinkage expansion of the material and the assembly tolerances. When light is emitted from the edge of the light guide plate 212 (light leakage), the light is easy to be reflected by the reflective sheet corresponding to the gap G, so that a bright pattern is formed at the gap G. Therefore, the backlight module 20 of the embodiment may be further disposed with a material or a structure having a low reflectivity (high absorbance) in the gap G to improve the problem of bright pattern at the gap G, which will be described in detail below.

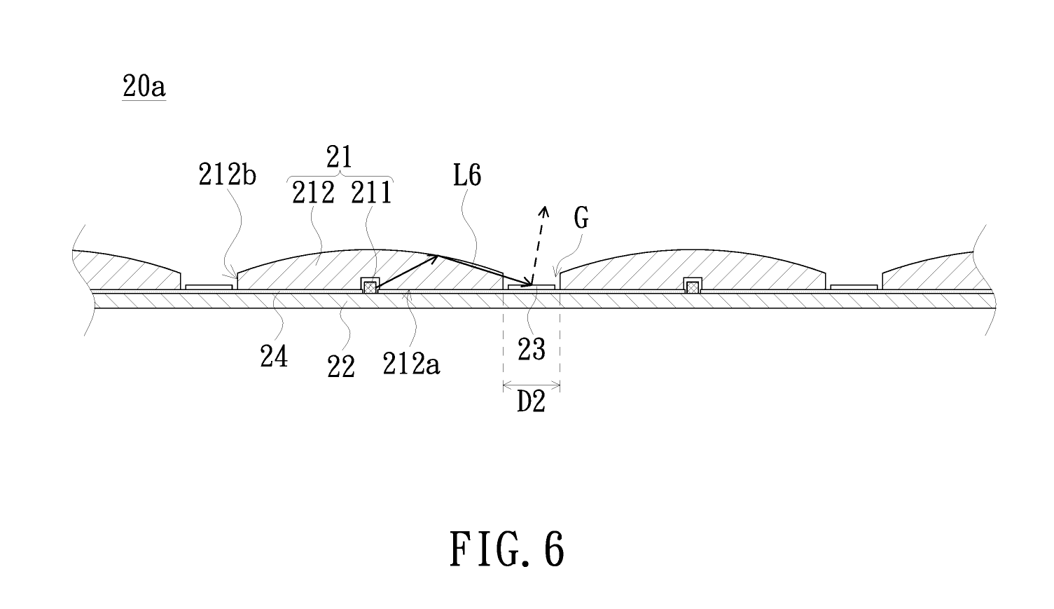

FIG. 6 is a schematic cross-sectional view of a backlight module in accordance with another embodiment of the invention. Please refer to FIG. 6. The backlight module 20a of the embodiment is similar to the backlight module 20 of FIG. 5, and the main difference is that the backlight module 20a further includes a light absorbing layer 23. The light absorbing layer 23 is, for example, adjacent to the bottom surface 212a of the light guide plates 212 and is disposed corresponding to the gap G between any two adjacent light guide plates 212. Specifically, the backlight module 20a may further include a reflective layer 24. The reflective layer 24 is disposed on the bottom surface 212a of the light guide plate 212 and located above the substrate 22, and the light absorbing layer 23 is disposed on the reflective layer 24 corresponding to the gap G, but the invention is not limited thereto. In other embodiments, the light absorbing layer 23 may be located on other plate materials covering the gap G, such as a back plate generally used in a backlight module or a substrate connecting any two adjacent surface light source assemblies. In addition, same as the light absorbing layer 13 in the above embodiment, the light absorbing layer 23 is, for example, a paint, a tape or a plating layer having a low reflectance (high light absorption). Further, in one embodiment, the width D2 of the gap G is greater than 0 mm and less than or equal to 3 mm. In the embodiment, the gap G is exemplified by having a coincident width D2; however, in other embodiments, the width D2 of the gap G may not be coincident.

As a result, the light (light L6) emitted from the side surface 212b of the light guide plate 212 can be absorbed by disposing the light absorbing layer 23 at the gap G of any two adjacent light guide plates 212, so that the problem of bright pattern at the gap G can be improved and accordingly the light emission uniformity of the backlight module 20a is improved.

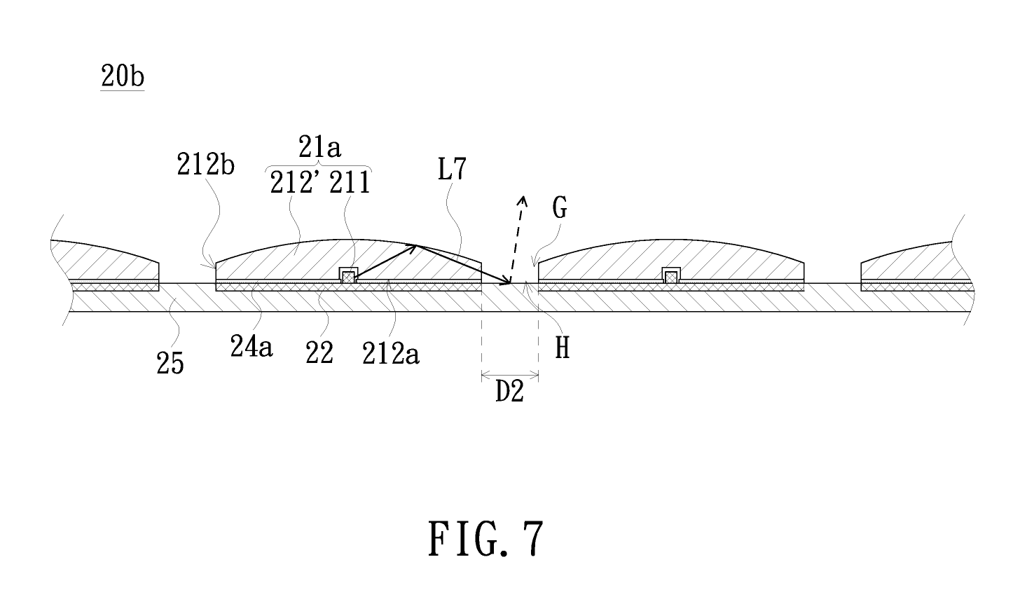

FIG. 7 is a schematic cross-sectional view of a backlight module in accordance with another embodiment of the invention. Please refer to FIG. 7. The backlight module 20b of the embodiment is similar to the backlight module 20 of FIG. 5, and the main difference is that the backlight module 20b of the embodiment further includes a reflective layer 24a. The reflective layer 24a is disposed on the bottom surfaces 212a of the light guide plates 212′ of the surface light source assembly 21a. There is a gap G between any two adjacent light guide plates 212′, the reflective layer 24a has a plurality of openings H, and each of the openings H corresponds to the respective gap G

Specifically, the reflective layer 24a of the embodiment includes, for example, a plurality of reflective sheets (FIG. 7 is exemplified by four reflective sheets), and the openings H are the gaps G between the reflective sheets. The backlight module 20b further includes, for example, a back plate 25. The reflective sheets are disposed between the bottom surfaces 212a of the light guide plates 212′ and the back plate 25. In addition, the opening H and the gap G in FIG. 7 have the same width, but the opening H of the invention may be adjusted in accordance with the design requirements, and the specific shape and size of the opening H are not limited. For example, in other embodiments, the reflective layer 24a may have only one reflective sheet. The reflective sheet is disposed on the bottom surfaces 212a of the light guide plates 212′, and the openings H are, for example, in a stripe-like groove and distributed in the gaps G.

As a result, the light (light L7) leaking to the gap G is not reflected by the reflective layer 24a having the opening H corresponding to the gap G, so that the problem of bright pattern at the gap G can be improved.

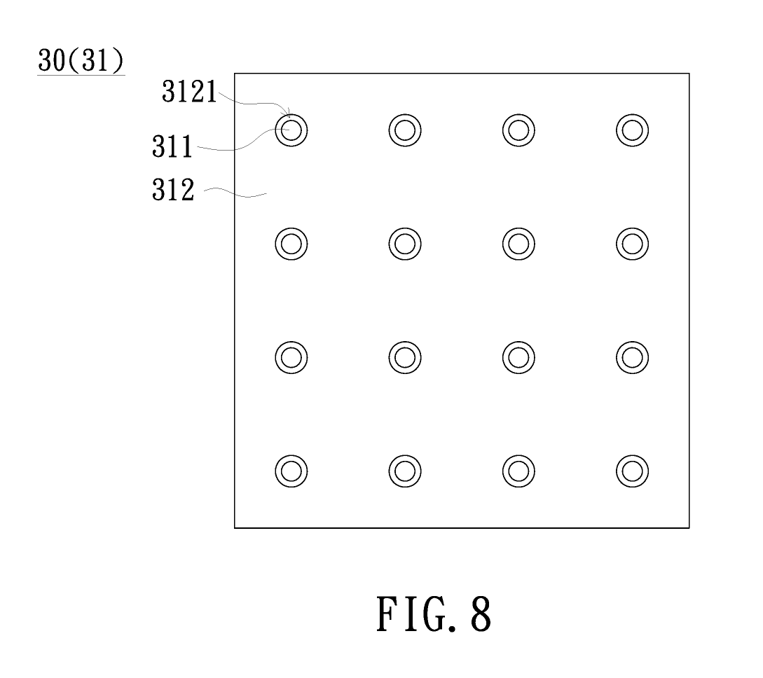

Each of the surface light source assemblies of the above backlight module is exemplified by including one light emitting element; however, in other embodiments of the invention, each of the surface light source assemblies may include a plurality of light emitting elements. Specifically, FIG. 8 is a schematic bottom view of a backlight module in accordance with another embodiment of the invention. Please refer to FIG. 8. The backlight module 30 of the embodiment includes a surface light source assembly 31. The surface light source assembly 31 includes a plurality of light emitting elements 311 and a light guide plate 312. The light guide plate 312 has a plurality of accommodation grooves 3121, and the light emitting elements 311 are disposed in the accommodation grooves 3121. In addition, the surface light source assembly 31 may be a surface light source assembly of any of the embodiments described above, such as the surface light source assembly 10, 10a or 10b. Since employing the surface light source assembly of any of the above embodiments, the backlight module 30 can provide a surface light source having better luminance uniformity.

In summary, since the light emitting element disposed in the accommodation groove of the light guide plate has the annular light emitting side surface which emits light to the corners of the light guide plate in addition emits light to the side surfaces of the light guide plate, the surface light source assembly of the embodiment of the invention can improve the problem of corner dark area of the light guide plate of the conventional mix-type backlight module. Further, the light emission surface of the light guide plate is designed as a convex surface which can change the incident angle of the light in the light guide plate on the light emission surface, the light originally to be reflected to the side surface of the light guide plate and leaked from the side surface will be reflected to the light guide plate and exit from the light emission surface, thus, the light leakage at the edge of the light guide plate of the conventional mix-type backlight module is improved. As a result, the surface light source assembly of the embodiment can enhance luminance uniformity and suppress edge light leakage. In addition, since the annular gap is disposed with the light absorbing layer, the surface light source assembly of the embodiment of the invention can improve the problem of bright pattern occurring on the light guide plate corresponding to the annular gap, thereby improving the uniformity of light emission. Since employing a plurality of the above surface light source assemblies, the backlight module of the embodiment of the invention can improve the problem of having uneven luminance in the conventional mix-type backlight module. In addition, since the light absorbing layer is disposed in the gap between any two adjacent light guide plates or openings are disposed in the reflective layer, the backlight module of the embodiment of the invention can improve the problem of having uneven light emission at the positions where the light guide plates are stitched, thereby improving the uniformity of light emission.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A surface light source assembly, comprising:
at least one light emitting element, having an annular light emitting side surface; and
a light guide plate, having a bottom surface and a light emission surface opposite to each other, wherein the bottom surface has at least one accommodation groove to accommodate the at least one light emitting element, each of the at least one accommodation groove has a light incident surface, and the light incident surface surrounds the annular light emitting side surface of the light emitting element located in the accommodation groove,
wherein the light emission surface of the light guide plate is a convex surface.

2. The surface light source assembly according to claim 1, wherein there is an annular gap between the light incident surface and the annular light emitting side surface, and the surface light source assembly further comprises a light absorbing layer adjacent to the bottom surface of the light guide plate and disposed corresponding to the annular gap.

3. The surface light source assembly according to claim 2, further comprising a substrate, wherein the at least one light emitting element is disposed on the substrate and accommodated in the at least one accommodation groove, and the light absorbing layer is disposed on the substrate.

4. The surface light source assembly according to claim 3, wherein the substrate is a printed circuit board, and the light absorbing layer is a printed pattern layer of the substrate.

5. The surface light source assembly according to claim 3, further comprising a reflective sheet disposed on the bottom surface of the light guide plate and located on the substrate, wherein the reflective sheet has at least one opening, and the at least one light emitting element is penetrately disposed in the at least one opening.

6. The surface light source assembly according to claim 5, wherein the light absorbing layer is disposed on the reflective sheet.

7. The surface light source assembly according to claim 1, wherein a portion of the light emission surface of the light guide plate corresponding to the at least one accommodation groove is a matte surface.

8. The surface light source assembly according to claim 2, wherein a portion of the light emission surface of the light guide plate corresponding to the annular gap is a matte surface.

9. The surface light source assembly according to claim 2, wherein a width of the annular gap is greater than 0 mm and less than or equal to 1 mm.

10. The surface light source assembly according to claim 1, wherein a number of the at least one light emitting element is plural, a number of the at least one accommodation groove is plural, and the plurality of light emitting elements are disposed in the plurality of accommodation grooves respectively.

11. The surface light source assembly according to claim 1, wherein each of the at least one light emitting elements includes a top surface and a lower bottom surface opposite to each other, the lower bottom surface is adjacent to the bottom surface of the light guide plate, the annular light emitting side surface is connected between the top surface and the lower bottom surface, and the top surface does not emit light.

12. A backlight module, comprising:
a plurality of surface light source assemblies claimed in claim 1, wherein the light guide plates of the surface light source assemblies are spliced to each other.

13. The backlight module according to claim 12, wherein there is a gap between any two adjacent light guide plates, and the backlight module further comprises a light absorbing layer adjacent to the bottom surfaces of the light guide plates and disposed corresponding to the gap between any two adjacent light guide plates.

14. The backlight module according to claim 12, wherein there is a gap between any two adjacent light guide plates, and a width of the gap is greater than 0 mm and less than or equal to 3 mm.

15. The backlight module according to claim 12, further comprising a reflective layer disposed on the bottom surfaces of the light guide plates, wherein there is a gap between any two adjacent light guide plates, the reflective layer has a plurality of openings, and the openings correspond to the gaps.

16. The backlight module according to claim 15, wherein the reflective layer comprises a plurality of reflective sheets, and the openings are the gaps between the reflective sheets.
